(19) United States
(12) Patent Application Publication
(10) Pub. No.: US 2014/0317973 A1
(43) Pub. Date: Oct. 30, 2014

(54) Three-dimensional signboard and a method for manufacturing the same

(71) Applicant: Xinghua Shen, Jiangsu (CN)

(72) Inventor: Xinghua Shen, Jiangsu (CN)

(73) Assignee: WU JIANG YU XING METAL ART DECORATION CO., LTD., Jiangsu (CN)

(21) Appl. No.: 14/363,307

(22) PCT Filed: Jul. 20, 2012
(86) PCT No.: PCT/CN2012/078917

§ 371 Date: Jun. 6, 2014

(30) Foreign Application Priority Data
Dec. 6, 2011 (CN) 201110400901.6

(51) Int. Cl. G09F 13/00; G09F 7/00

(52) U.S. Cl. CPC G09F 13/00; G09F 7/00
USPC 40/541; 40/584; 264/40.1

(57) ABSTRACT

A three-dimensional signboard and a method for manufacturing the same are provided. The signboard comprises: an upper-layer unit and a lower-layer unit connected to each other. The upper-layer unit comprises a main body portion (1) reflecting a identification shape of the three-dimensional signboard. The lower-layer unit comprises a side wall portion (3) connected to the main body portion (1), and the side wall portion (3) encloses to form a cavity for supporting the main body portion (1). A connection portion (2) is further provided between the main body portion (1) and the side wall portion (3). An upper edge of the connection portion (2) is connected to a lower edge of the main body portion (1), and a lower edge of the connection portion (2) is connected to an upper edge of the side wall portion (3). The signboard of the present invention has a strong stereoscopic effect and is easily identified, and a method for manufacturing a three-dimensional signboard has simple procedures.

### CROSS-REFERENCE TO RELATED APPLICATION

This application is a continuation under 35 U.S.C. Sections 365(c) and 120 of International Application No. PCT/CN2012/078917 filed on 20 Jul. 2012 and published on 13 Jun. 2013 as WO 2013/082945, which claims priority from Chinese Patent Application No. 201110400901.6 filed on 6 Dec. 2011, which are hereby incorporated by reference herein in its entirety.

### TECHNICAL FIELD

The present invention relates to the field of advertising products, particularly to a three-dimensional signboard and a method for manufacturing the same.

### BACKGROUND ART

Nowadays, in the city signboard identification lighting technology, beautiful metal signboards exist in daytime and sparkling metal signboards with a strong stereoscopic effect exist at night. The durable metal signboards meet the trends of city signboards sign. Currently, traditional convex surface signboards, parallel surface signboards, metal shell reflective signboards, metal shell planar surface luminous signboards, organic glass material front luminous signboards and the like are used as basic luminous signboards, which has the defects of bad visual effect in daytime, single shape, less stereoscopic effect at night, poor aesthetics and the like. In addition, when a viewer is far from the signboard, e.g. the signboard is set on the higher buildings, or the viewer recognizes the signboard far away, it is difficult for the viewer to recognize accurately the signboard due to lack of brightness or unfocused brightness of the signboard.

### SUMMARY OF INVENTION

### Technical Problems to be Solved

Technical problems sought to be solved by the present invention are to improve the visual effect in daytime, stereoscopic effect and durability of the signboard, and identification display effect of the signboard at night, and further to improve the accuracy of recognizing the signboard far away at night.

### Technical Solutions

In order to solve the technical problems above, the present invention provides a three-dimensional signboard, comprising: an upper-layer unit and a lower-layer unit which are connected to each other, the upper-layer unit comprising a main body portion for reflecting an identification shape of the three-dimensional signboard; and the lower-layer unit comprising a side wall portion connected to the main body portion, the side wall portion encloses to form a cavity for supporting the main body portion.

Wherein, at least one connection portion is provided between the main body portion and the side wall portion, an upper edge of the connection portion is connected to a lower edge of the main body portion, and a lower edge of the connection portion is connected to an upper edge of the side wall portion.

Wherein, the main body portion is formed by at least one unit plane, the unit plane comprising a horizontal surface, a vertical surface, an inclined surface, a convex surface with a [symbol] -shaped cross section, a concave surface with a [symbol] -shaped cross section, a concave cambered surface, a convex cambered surface and a curved chambered surface.

Wherein, the connection portion and/or the side wall portion is formed by at least one of unit plane comprising a horizontal surface, a vertical surface, an inclined surface, a convex surface with a [symbol] -shaped cross section, a concave surface with a [symbol] shaped cross section, a concave cambered surface, a convex cambered surface and a curved chambered surface.

Wherein, the surfaces of the main body portion, the side wall portion and the connection portion are in the sealed-shape; alternatively, a part or all of the surfaces of the main body portion, the side wall portion and the connection portion are in the hollowed-shape. The main body portion, the connection portion and the side wall portion are made of materials including metal, organic glass, Chevron board, glass fiber reinforced plastics, wood, polycarbonate, or polyvinyl fluoride.

Wherein, a mounting plate is provided at the bottom of the side wall portion, an upper surface and/or a lower surface of the mounting plate is provided with light-emitting elements.

The present invention also provides a method for manufacturing a three-dimensional signboard, wherein at least one of a main body portion, a connection portion and a side wall portion of the three-dimensional signboard is formed by at least one unit plane comprising a horizontal surface, a vertical surface, an inclined surface, a convex surface with a [symbol] -shaped cross section, a concave surface with a [symbol] shaped cross section, a concave cambered surface, a convex cambered surface and a curved chambered surface. The unit planes forming the three-dimensional signboard comprises at least one inclined surface, convex surface with a [symbol] -shaped cross section, concave surface with a [symbol] shaped cross section. The method for manufacturing the three-dimensional signboard comprising:

S1: providing a wood or Chevron board mold for the inclined surface, [symbol] -shaped convex surface or the [symbol] shaped concave surface in desired dimensional scale at the center of the main body portion according to a pattern of the inclined surface, convex surface with the [symbol] -shaped cross section or the concave surface with the [symbol] shaped cross section which form the signboard;

S2: dividing the mold into a plurality of regional components with different identification tags when the inclined surface, the [symbol] -shaped convex surface or the [symbol] shaped concave surface is located at the center of the main body portion; and then covering surfaces of the regional components with a rubbing material to obtain planar extension units corresponding to each regional components, and cutting materials and labeling the cut plates with tags corresponding each regional components;

performing outward scaling based on the inclined surface, [symbol] -shaped convex surface or [symbol] shaped concave surface at the center of the main body portion according to shapes of other unit planes forming the main body portion, the connection portion and the side wall portion, obtaining sizes of the other unit planes by calculation or simulation, and cutting the material correspondingly;

when the inclined surface, the [symbol] -shaped convex surface or the [symbol] shaped concave surface is not disposed at the center of the main body portion, performing outward scaling based on the mold for the inclined surface, the [symbol] -shaped convex surface or the [symbol] shaped concave surface at the center of the main body portion according to predetermined shapes of other unit planes forming the signboard, obtaining sizes of unit planes beyond the center of the main body portion by calculation or simulation and cutting the material correspondingly; and obtaining a size of the unit plane at the center of the main body portion by the calculation or simulation according to a height of the unit plane at the center of the main body portion of the signboard and a width thereof projected on the horizontal and then cutting the material correspondingly;

S3: obtaining sizes of other unit planes by the calculation according to the mold for the inclined surface, the [symbol] -shaped convex surface or the [symbol] shaped concave surface manufactured at the center of the main body portion when the unit planes forming the signboard comprise a unit plane having at least two inclined surfaces, the [symbol] -shaped convex surfaces or the [symbol] shaped concave surfaces and there is the same inclined angle for the inclined surfaces and inclined surfaces forming the [symbol] -shaped convex surface or the [symbol] shaped concave surface;

repeatedly performing the steps S1 and S2 sequentially based on different inclined angles of inclined surfaces or inclined surfaces forming the [symbol] -shaped convex surface or the [symbol] shaped concave surface when the unit planes forming the signboard comprise at least two inclined surface, the [symbol] -shaped convex surfaces or the [symbol] shaped concave surfaces and there are different inclined angles for the inclined surfaces or inclined surfaces forming the [symbol] -shaped convex surface or the [symbol] shaped concave surface;

S4: integrating the plates cut in the step S2 according to the tags and the shapes of the unit planes based on the patterns of the signboard so as to form an overall identification shape of the three-dimensional signboard;

Wherein, heights of an overall signboard and the unit planes forming the signboard and widths thereof projected on the horizontal are determined When the unit planes forming the signboard comprises the horizontal surface, the vertical surface, the convex chambered surface or the concave chambered surface, sizes of the unit planes are obtained by the calculation comprising: calculating sizes of the planar extension units of the unit planes according to the width of the unit planes projected on the horizontal and the height thereof; and when the unit planes forming the signboard comprises the convex chambered surface or the concave chambered surface with the curved surface, obtaining sizes of the unit planes by the simulation comprising: printing patterns of the cross sections of the signboard, simulating and copying with a soft rope or a sticker according to the patterns printed and calculating the size of the convex chambered surface or concave chambered surface;

Wherein, perforating hollowed surfaces of the main body portion, the connection portion and the side wall portion, wherein perforated regions in predetermined positions are located by the calculation or the simulation, and then the perforated regions located are perforated; the hollowed regions of the main body portion and the connection portion are set off by a non-opaque resin material, non-opaque organic glass sheet material or non-opaque adhesive material; and the main body portion, the connection portion and the side wall portion are manufactured from materials including metal, organic glass, Chevron board, glass fiber reinforced plastics, wood, polycarbonate or polyvinyl fluoride.

The present invention also provides a method for manufacturing a three-dimensional signboard, wherein at least one of a main body portion, a connection portion and a side wall portion of the signboard is formed by at least one unit plane, the unit plane comprising a horizontal surface, a vertical surface, a concave chambered surface, a convex chambered surface and a curved chambered surface; the method comprising:

Determining heights of an overall signboard and the unit planes forming the signboard and widths thereof projected on the horizontal; when the unit planes forming the signboard comprise the horizontal surface, the vertical surface, the convex chambered surface or the concave chambered surface, sizes of the unit planes are obtained by the calculation comprising calculating sizes of planar extension units of the unit planes according to the widths of the unit planes projected on the horizontal and the heights thereof; and when the unit planes forming the signboard are the convex chambered surface or concave chambered surface and the surface of the convex chambered surface or concave chambered surface is a curved surface, sizes of the unit planes can be obtained by the simulation comprising printing patterns of a cross section of the signboard, simulating and copying by using a soft rope or a sticker according to the patterns printed, and calculating the size of the convex chambered surface or concave chambered surface;

Cutting materials according to the sizes of the unit planes forming the signboard, and integrating the cut material according to the patterns of the signboard so as to form an overall identification shape of the three-dimensional signboard.

Wherein, perforating hollowed surfaces of the main body portion, the connection portion and the side wall portion, wherein perforated regions in predetermined positions are located by the calculation or the simulation, and then perforating the perforated regions located; the hollowed regions of the main body portion and the connection portion are set off by a non-opaque resin material, non-opaque organic glass sheet material or non-opaque adhesive material; and the main body portion, the connection portion and the side wall portion are manufactured from materials including metal, organic glass, Chevron board, glass fiber reinforced plastics, wood, polycarbonate or polyvinyl fluoride.

### Beneficial Effects

For the signboard provided by the technical solutions above, the shape of the signboard is presented by the main body portion and configured such that the connection portion connects the main body portion and the side wall portion supports the connection portion to enhance the stereoscopic effect of the signboard. The main body portion, the connection portion and the side wall portion are formed by basic unit planes and have varied shapes. The signboard is made of metal, so that the signboard has a better display effect in the daytime, and is more durable. In order to improve the display effect at night, a mounting plate with light-emitting elements attached thereto is provided at the bottom of the side wall portion, and the surfaces of the signboard are perforated to pass light rays to display the signboard profile clearly, so as to provide more accurate identifying effect thereof. In the method of manufacturing described above, only one mold for the unit plane is needed for the same signboard and there is even no need to manufacture a mold; the calculation or simulation is further utilized to obtain the size of each unit plane; and the raw materials are cut from the plates, and then finished by integration, thereby shortening the production process, saving the material, and achieving the more beautiful signboard.

### BRIEF DESCRIPTION OF THE DRAWINGS

FIG. 1 is a cross sectional view of a main body portion and a connection portion of a three-dimensional signboard in the first example and the second example of the present invention.

FIG. 2 is a cross sectional view of a main body portion and a connection portion of a three-dimensional signboard in the third example of the present invention; and

FIG. 3 is a cross sectional view of a three-dimensional signboard in the fourth example of the present invention.

### REFERENCE NUMERALS

a. main body portion
b. connection portion
c. side wall portion

### DETAILED DESCRIPTION OF THE PREFERRED EMBODIMENTS

The further description to specific examples of the present invention is made below in conjunction with the drawings and the examples. The following examples are illustrative merely, but not to limit the scope of the present invention.

### The First Example

The technical solution of this example is applicable not only to a three-dimensional word signboard, but also applicable to various signboards of regular or irregular pattern shape. This example takes three-dimensional characters as a example, specifically capital letters is used to introduce the specific structure of the signboard.

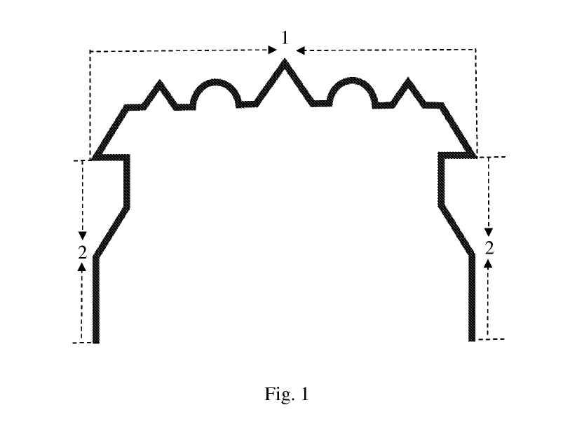

FIG. 1 illustrates a cross sectional view of a three-dimensional signboard of this example. More specifically, the signboard comprises an upper-layer unit and a lower-layer unit connected to each other by welding. The upper-layer unit comprises a main body portion 1 for reflecting each stroke of the letter in the signboard. The lower-layer unit comprises a side wall portion 3 (not shown in FIG. 1) connected to the main body portion 1, wherein the side wall portion 3 encloses to form a cavity for supporting the main body portion 1. In order to enhance the stereoscopic effect, a connection portion 2 is arranged between the main body portion 1 and the side wall portion 3.

In order to enhance the stereoscopic effect, the visual effect and the varied shapes, the main body portion 1 is configured to be formed by at least one unit plane, and the connection portion 2 is configured to be formed by at least one unit plane. The main body portion 1 may have a shape same as or different from the shape of the connection portion 2. The main body portion 1 and the connection portion 2 both have a unit plane which is selected one or more from the group consisting of a horizontal surface, a vertical surface, an inclined surface, a convex surface with a [symbol] -shaped cross section, a concave surface with a [symbol] shaped cross section, a convex chambered surface, a convex chambered surface and a curved chambered surface. The number of the unit planes is further determined. At last the unit planes are arranged or combined according to the type and number of the selected unit planes to form shapes desired for the main body portion 1 and the connection portion 2.

In this example, it is easy to determine shapes of the unit planes of the horizontal surface and the vertical surface without various variations. The unit planes with the inclined surface, the convex surface with a [symbol] -shaped cross section and the concave surface with a [symbol] shaped cross section have various variations according to their inclined angles. For the unit planes with the convex chambered surface and the concave chambered surface, the chambered surfaces rotate around their circle centers, which will cause various chambered surface variations because of different rotation angles. The unit planes with the curved chambered surface will have various shapes. Take FIG. 1 as an example, the main body portion 1 includes six horizontal surfaces, three [symbol] -shaped convex surfaces, two inclined surfaces and two convex chambered surfaces, which form the symmetrical main body portion 1 shown in FIG. 1. The connection portion 2 includes one horizontal surface, two vertical surfaces and one inclined surface, which form the connection portion 2 shown in FIG. 1.

Obviously, the main body portion and the connection portion may have various shapes and may obtain the desired effect by increasing the type or number of the unit planes to randomly arrange them.

The surface of the main body portion 1 can be configured with the sealed-shape, or a part of or all of the regions are configured with the hollowed-shape. In order to enhance the visual effect of the signboard, the main body portion 1 is made of liner board with suitable color, such as organic glass or the like, and a variety of patterns are sprayed or silk-screen printed on the liner board. The surfaces of the side wall portion and the connection portion 2 are configured with the sealed-shape, or a part of or the all of the region thereof are configured with the hollowed-shape. In order to enhance the strength and durability, the main body portion 1, the side wall portion and the connection portion 2 are made of metal, organic glass, Chevron board, glass fiber reinforced plastics, wood, polycarbonate or polyvinyl fluoride, preferably the metal. For the hollowed surfaces described above, the hollowed pattern may be any shapes, such as circular, triangular, polygonal, grid-like, and heart-shaped, etc.

The signboard structure in the example above can be applied to three-dimensional fabrication of Chinese characters, English letters, Arabic numerals, etc., as well as special symbols and patterns.

In order to use signboards according to the above-described example for enhancing the identification effect at night, a mounting plate is set in the bottom of the side wall portion. Light-emitting elements are provided on an upper surface and/or a lower surface of the mounting plate. The light emitting elements may be one or more of LED light source, neon light, or incandescent lamp. By setting the power and color of the light emitting elements, and controlling the adjustment of brightness of the light emitting elements, diversity of the light emitting performance of the signboard and beautiful displaying can be obtained.

### The Second Example

The present example provides a method for manufacturing the signboard based on the first example. The method of this example is applicable to manufacture the signboards with any shaped main body portions, connection portions and side wall portions. The method for manufacturing the signboard is discussed based on shapes of the cross sections of the main body portion and the connection portion as patterns shown in FIG. 1 in the following description. The main body portion 1 and the connection portion 2 in FIG. 1 are formed by at least one unit plane. The unit plane comprises a horizontal surface, a vertical surface, an inclined surface, a convex surface with a [symbol] -shaped cross section, a concave surface with a [symbol] shaped cross section, a convex chambered surface, a concave chambered surface and a curved chambered surface. The unit planes forming the signboard include at least one inclined surface, convex surface with a [symbol] -shaped cross section or concave surface with a [symbol] shaped cross section. The main body portion 1 and the connection portion 2 included in the signboard in this example totally comprise three similar convex surfaces with a [symbol] -shaped cross section formed by the inclined surfaces, marked as ridge-shaped surfaces, two projected circular chambered surfaces, eight horizontal surfaces, four inclined surfaces with same inclined angles and four vertical surfaces, by the combination of the unit plane above, the main body portion and the connection portion with symmetrical structure are formed, and the central line of the center of the main body portion is symmetrical axis, inclined angels of inclined surfaces of the same side of symmetrical axis are completely identical. The signboard in this example is manufactured by the following steps:

S1: providing a wood or Chevron board mold for the inclined surface, the [symbol] -shaped convex surface or the [symbol] shaped concave surface in desired dimensional scale at the center of a main body portion according to a pattern of the inclined surface, the convex surface with the [symbol] -shaped cross section or the concave surface with the [symbol] shaped cross section which forms the signboard;

Especially, the mold for the ridge-shaped surfaces at the center of the main body portion 1 is produced with molding materials which are difficult to deform such as Chevron board or mechanical wood board and the like, and has a size identical to the actually desired size of the signboard.

S2: dividing the mold for the ridge-shaped surfaces into a plurality of regional components with different identification tags because the ridge-shaped surfaces are located at the center of the main body portion 1; and then covering the surfaces of regional components with a rubbing material to obtain planar extension units corresponding to each regional component, and cutting materials based on the planar extension units, and labeling them with tags corresponding each regional components. In this step, a sticker or adhesive paper is used as the rubbing material.

Then, performing scaling to two sides based on the ridge-shaped surface at the center of the main body portion 1 according to shapes of other unit planes forming the main body portion 1 and the connection portion 2, obtaining sizes of the other unit planes by calculation or simulation, and cutting the material correspondingly.

Specifically, the heights of the overall signboard and the unit planes forming the signboard and widths thereof projected on the horizontal are determined When the unit planes forming the main body portion 1 and/or the connection portion 2 are the horizontal surface, the vertical surface, the convex chambered surface or the concave chambered surface, the size of the unit plane is obtained by the calculation comprising: calculating sizes of the planar extension units of the unit planes according to the width of the unit planes projected on the horizontal and the height thereof. When the unit planes forming the main body portion and/or the connection portion are the convex chambered surfaces or concave chambered surfaces and the convex chambered surfaces or concave chambered surfaces are curved surfaces, sizes of the unit planes are obtained by using the simulation comprising: printing patterns of the cross sections of the main body portion and/or connection portion, simulating and copying with a soft rope or a sticker according to the patterns printed, and calculating the size of the convex chambered surface or concave chambered surface.

The unit planes in this example have regular geometrical shapes, so the calculation is used merely without using the simulation. The pattern at one side of the ridge-shaped surface is taken as an example and the pattern at other side thereof will be obtained accordingly. It is important to determine the widths of the planar extension units of the unit plane because the lengths thereof are determined by side-lengths of edges of the shape of the signboard. For the unit plane with the horizontal surface, the width thereof projected on the horizontal is only calculated. For the unit plane with the circular chambered surface, the arc length of the unit plane with the circular chambered surface, i.e. the widths of the planar extension units of the unit plane, will be obtained by calculating the width of the unit plane projected on the horizontal and the height thereof using the same principle. For the ridge-shaped surface similar to the ridge-shaped located at the center of the main body portion 1, the widths of two side faces forming the ridge-shaped surface will be obtained by calculating the base length of a triangle in which the ridge-shaped is located and the height from the vertex of the triangle to the base of the triangle. For the inclined surface, width of the inclined surface will be obtained by calculating the width thereof projected on the horizontal and the height from the vertex of the inclined surface to the plane on which it is projected. For the vertical surface, it is available to calculate its height.

It is assumed that the unit plane forming the main body portion and the connection portion have the shape that is not included in FIG. 1, and the inclined surface or [symbol] -shaped convex surface or [symbol] shaped concave surface are not located at the center of the main body portion, a mold for the inclined surface, [symbol] -shaped convex surface or [symbol] shaped concave surface is still produced at the center of the main body portion. The previously-described scaling to two sides is performed based on the mold for the inclined surface, [symbol] -shaped convex surface or [symbol] shaped concave surface according to shapes of other unit planes forming the main body portion and the connection portion. The sizes of the other unit planes are obtained by the calculation or simulation, and the material is cut correspondingly; and meanwhile, the size of the unit plane at the center of the main body portion is obtained by the calculation or simulation according to the height of the unit plane at the center of the main body portion of the signboard and the width thereof projected on the horizontal, and then the material is cut correspondingly;

S3: obtaining sizes of other unit planes by the calculation according to the mold for the inclined surface, the [symbol] -shaped convex surface or the [symbol] shaped concave surface manufactured at the center of the main body portion when unit planes forming the main body portion and/or the connection portion comprise a unit plane having at least two inclined surfaces, the [symbol] -shaped convex surfaces or the [symbol] shaped concave surfaces and there is the same inclined angle for the inclined surfaces and inclined surfaces forming the [symbol] -shaped convex surface or the [symbol] shaped concave surface;

Repeatedly performing the steps S1 and S2 sequentially based on different inclined angles of inclined surfaces or inclined surfaces forming the [symbol] -shaped convex surface or the [symbol] shaped concave surface when the unit planes forming the signboard comprise the unit plane having at least two inclined surfaces, the [symbol] -shaped convex surfaces or the [symbol] shaped concave surfaces and there are different inclined angles for the inclined surfaces or inclined surfaces forming the [symbol] -shaped convex surface or the [symbol] shaped concave surface.

Specially, when the inclined surface, [symbol] -shaped convex surface or [symbol] shaped concave surface has various angles, it is required to produce the molds for many times, and sequentially scaling is performed according to the molds so as to obtain the suitably-sized plates with inclined surfaces, [symbol] -shaped convex surfaces or [symbol] shaped concave surfaces. Differently, the inclined surface, [symbol] -shaped convex surface or [symbol] shaped concave surface is located at the center of the main body portion, it is required to use a rubbing technique to separately produce the plates with the inclined surface, [symbol] -shaped convex surface or [symbol] shaped concave surface. When the inclined surface, [symbol] -shaped convex surface or [symbol] shaped concave surface is not located at the center of the main body portion, it is required merely to produce the mold on which the scaling is based without the rubbing technique; and

S4: integrating the plates cut in the step S2 according to the tags and the shapes of the unit planes based on the patterns of the signboard so as to form an overall identification shape of the three-dimensional signboard.

S5: cutting the plate for the side wall portion with the desired length and width from the plate used for the side wall portion according to the size of the lower edge of the connection portion connected to the side wall portion, and then connecting the plate for the side wall portion to the lower edge of the connection portion to form the overall three-dimensional signboard.

In the method in this example, it is required to perforate hollowed surfaces of the main body portion 1, the connection portion 2 and the side wall portion, wherein perforated regions in predetermined positions are located by the calculation or the simulation, and then the perforated regions located are perforated; the hollowed regions of the main body portion 1 and the connection portion 2 are set off by a non-opaque resin material, non-opaque organic glass sheet material or non-opaque adhesive material; and the main body portion 1, the connection portion 2 and the side wall portion are manufactured from materials including metal, organic glass, Chevron board, glass fiber reinforced plastics, wood, polycarbonate or polyvinyl fluoride.

### The Third Example

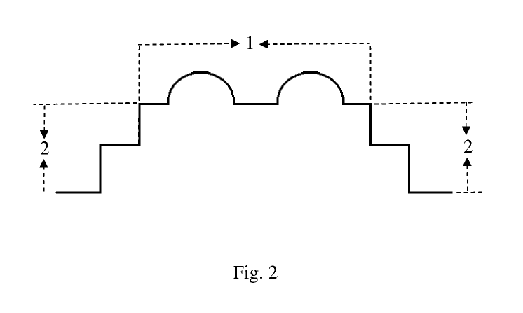

FIG. 2 illustrates patterns of cross sections of the main body portion 1 and the connection portion 2 of the signboard in this example, the main body portion 1 and the connection portion 2 of the signboard are formed by at least one unit plane comprising a horizontal surface, a vertical surface and a convex chambered surface. The difference of the process of manufacturing the main body portion 1 and the connection portion 2 between this example and the first example lies in directly performing the calculation merely without producing the mold. The calculation comprises the following steps: determining the heights of the overall signboard and the unit planes forming the signboard and the widths thereof projected on the horizontal, and calculating the sizes of the planar extension units of the unit planes according to the width and height thereof projected on the plane; When the unit planes forming the main body portion and/or the connection portion are the convex chambered surfaces or concave chambered surfaces and the convex chambered surfaces or concave chambered surfaces are curved surfaces, sizes of the unit planes are obtained by using the simulation comprising: printing patterns of the cross sections of the main body portion and/or connection portion, simulating and copying with a soft rope or a sticker according to the patterns printed, and calculating the size of the convex chambered surface or concave chambered surface. The convex chambered surface in this example is regular circular chambered surface and thus no simulation is used.

Cutting the materials is performed according to the size of the unit planes forming the main body portion 1 and/or the connection portion 2, and then the integration is performed according to the patterns of the identification tags so as to form an overall identification shape of three-dimensional signboard including main body portion 1 and the connection portion 2. Afterwards, a plate for the side wall portion having desired length and width is cut from a plate used for the side wall portion according to a size of lower edge of the connection portion 2 connected to the side wall portion, and the plate for the side wall portion is connected to the lower edge of the connection portion 2 so as to form the overall three-dimensional signboard.

In this example, perforating hollowed surfaces of the main body portion, the connection portion and the side wall portion, wherein perforated regions in predetermined positions are located by the calculation or the simulation, and then perforating the perforated regions located; the hollowed regions of the main body portion and the connection portion are set off by a non-opaque resin material, non-opaque organic glass sheet material or non-opaque adhesive material; and the main body portion, the connection portion and the side wall portion are manufactured from materials including metal, organic glass, Chevron board, glass fiber reinforced plastics, wood, polycarbonate or polyvinyl fluoride.

In this example, when the plates used for the each portion of the signboard are made of metal, the signboard is integrated by welding such as argon arc welding, electrical welding, aluminum soldering or tin soldering and the like. Before or after the portions are welded, the hollowed surfaces of the main body portion, the connection portion and the side wall portion are perforated, and the perforated shape can be circular, triangular, polygonal, grid-like, and heart-like, etc. In addition, in order to achieve the durability, the connection portion and the side wall portion are made of metals, and the main body portion is made of organic glass or transparent tapes with better transmittance or other materials to enhance the transmission of light.

### The Fourth Example

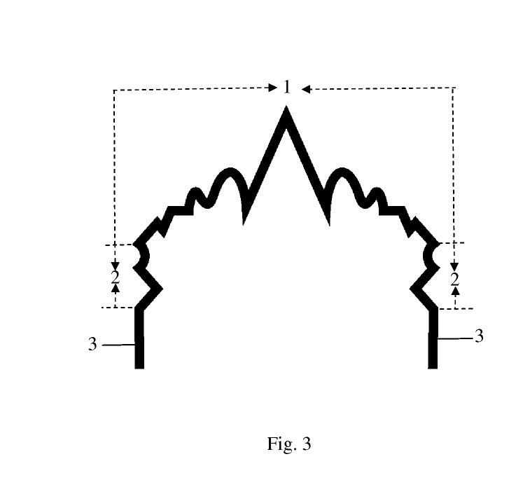

FIG. 3 illustrates patterns of cross sections of the main body portion 1, the connection portion 2 and the side wall portions 3 forming the signboard in this example, the main body portion 1 and the connection portion 2 of the three-dimensional signboard are formed by at least one unit plane, respectively. The unit plane comprises a horizontal surface, a vertical surface, an inclined surface, a convex surface with a [symbol] -shaped cross section, a concave surface with a [symbol] shaped cross section and the variant thereof, the variant of a concave chambered surface and a curved chambered surface; the side wall portion 3 is formed by the vertical surface. In this example the main body portion 1 and the connection portion 2 have symmetrical patterns in the cross section, and have the manufacturing process similar to that in the first example, comprising: firstly, producing a mold for the convex surface with a [symbol] -shaped cross section at the center of the main body portion 1, and performing the region-dividing and the rubbing, then executing scaling to two sides based on the [symbol] -shaped convex surface at the center of the main body portion 1 and then obtaining the size of the unit plane with the curved chambered surface by the simulation and obtaining the size of the unit plane with the horizontal surface by the calculation successively. Afterwards, an inclined angle of the inclined surface forming the [symbol] shaped concave surface connected with the horizontal surface unit plane is different from that of the inclined surface forming the [symbol] -shaped convex surface at the center of the main body portion 1, so the mold is again opened at the center of the main body portion 1 and the opened mold has a shape similar to that of the [symbol] shaped convex surface; and the calculation is executed according to the opened mold to obtain a size of the unit plane with asymmetrical [symbol] shaped concave surface. Then, when another inclined surface connected to the [symbol] shaped concave surface forms an inclined angle which is different from the above described inclined angles, there is a need to open a mold at the center of the main body portion 1, and the scaling and the calculation is performed based on the mold to obtain the size of the inclined surface. The geometric dimension parameters of each unit plane of the main body portion 1 can be obtained by the above process and then the material is cut.

In the process of manufacturing the connection portion 2, firstly, performing the calculation based on the mold produced at center of the main body portion 1 for the first time so as to obtain the geometric dimension of the circular chambered surface forming the connection portion 2; and for a variant unit plane with symmetric [symbol] shaped concave surfaces formed by two inclined surfaces for connecting the circular chambered surface and the side wall portion 3, opening a mold for the inclined surfaces with the same inclined angle at the center of the main body portion 1 according to the inclined angles of the two inclined surfaces, and obtaining the size of the variant unit plane with the [symbol] shaped concave surface by the calculation.

The size of the side wall portion 3 and the cutting are both identical to those in the first example. In this example, the calculation and the simulation have the steps identical to those in the first example.

It can be seen from the above examples that: the shape of the signboard of the present invention is presented by the main body portion and configured such that the connection portion connects the main body portion and the side wall portion supports the connection portion to enhance the stereoscopic effect of the signboard. The main body portion and the connection portion are all formed by basic unit planes and have varied shapes. The signboard is made of metal, so that the signboard has a better display effect in the daytime, and is more durable. In order to improve the display effect at night, a mounting plate with light-emitting elements attached thereto is provided at the bottom of the side wall portion, and the surfaces of the signboard are perforated to pass light rays to display the signboard profile clearly, so as to provide more accurate identifying effect thereof. In the method of manufacturing described above, only one mold is needed for the same signboard, the scaling is performed according to the size of the mold; and raw materials are cut from the plates, and then finished by integration, thereby shortening the production process, saving the material, and achieving the more beautiful signboard.

The foregoing description illustrates the preferred examples of the present invention, and it should be noted that many modifications and variations could be made without departing from the principle of the technology of the present invention and should be included in the scope of the present invention.

### INDUSTRIAL APPLICATION

With the signboard of the present invention, the shape of the signboard is presented by the main body portion and configured such that the connection portion connects the main body portion and the side wall portion supports the connection portion to enhance the stereoscopic effect of the signboard. The main body portion, the connection portion and the side wall portion are formed by basic unit planes and have varied shapes. The signboard is made of metal, so that the signboard has a better display effect in the daytime, and is more durable. In order to improve the display effect at night, a mounting plate with light-emitting elements attached thereto is provided at the bottom of the side wall portion, and the surfaces of the signboard are perforated to pass light rays to display the signboard profile clearly, so as to provide more accurate identifying effect thereof. In the method of manufacturing described above, only one mold for the unit plane is needed for the same signboard and there is even no need to manufacture a mold; the calculation or simulation is further utilized to obtain the size of each unit plane; and the raw materials are cut from the plates, and then finished by integration, thereby shortening the production process, saving the material, and achieving the more beautiful signboard.

What is claimed is:

1. A three-dimensional signboard, characterized in that, comprises:
an upper-layer unit and a lower-layer unit which are connected to each other;
wherein the upper-layer unit comprises a main body portion for reflecting an identification shape of the three-dimensional signboard; and
the lower-layer unit comprises a side wall portion connected to the main body portion, the side wall portion encloses to form a cavity for supporting the main body portion.

2. The three-dimensional signboard as claimed in claim 1, characterized in that, at least one connection portion is provided between the main body portion and the side wall portion, wherein an upper edge of the connection portion is connected to a lower edge of the main body portion, and a lower edge of the connection portion is connected to an upper edge of the side wall portion.

3. The three-dimensional signboard as claimed in claim 1, characterized in that, the main body portion is formed by at least one unit plane comprising a horizontal surface, a vertical surface, an inclined surface, a convex surface with a [symbol] -shaped cross section, a concave surface with a [symbol] shaped cross section, a convex chambered surface, a concave chambered surface and a curved chambered surface.

4. The three-dimensional signboard as claimed in claim 2 or 3, characterized in that, the connection portion and/or the side wall portion is formed by at least one unit plane comprising a horizontal surface, a vertical surface, an inclined surface, a convex surface with a [symbol] -shaped cross section, a concave surface with a [symbol] shaped cross section, a convex chambered surface, a concave chambered surface and a curved chambered surface.

5. The three-dimensional signboard as claimed in claim 2, characterized in that, the surfaces of the main body portion, the side wall portion and the connection portion are in the sealed-shape; alternatively, a part or all of the surfaces of the main body portion, the side wall portion and the connection portion are in the hollowed-shape; and the main body portion, the connection portion and the side wall portion are made of materials including metal, organic glass, Chevron board, glass fiber reinforced plastics, wood, polycarbonate, or polyvinyl fluoride.

6. The three-dimensional signboard as claimed in claim 2, characterized in that, a mounting plate is provided at the bottom of the side wall portion, wherein an upper surface and/or a lower surface of the mounting plate is provided with light-emitting elements.

7. A method for manufacturing a three-dimensional signboard, characterized in that, at least one of a main body portion, a connection portion and a side wall portion of the three-dimensional signboard is formed by at least one unit plane comprising a horizontal surface, a vertical surface, an inclined surface, a convex surface with a [symbol] -shaped cross section, a concave surface with a [symbol] shaped cross section, a concave cambered surface, a convex cambered surface and a curved chambered surface; and the unit planes forming the three-dimensional signboard comprise at least one inclined surface, convex surface with a [symbol] -shaped cross section or concave surface with a [symbol] shaped cross section, the method for manufacturing the three-dimensional signboard comprising:
S1: providing a wood or Chevron board mold for the inclined surface, the [symbol] -shaped convex surface or the [symbol] shaped concave surface in desired dimensional scale at the center of a main body portion according to a pattern of the inclined surface, the convex surface with the [symbol] -shaped cross section or the concave surface with the [symbol] shaped cross section which form the signboard;
S2: dividing the mold into a plurality of regional components with different identification tags when the inclined surface, the [symbol] -shaped convex surface or the [symbol] shaped concave surface is located at the center of the main body portion; and then covering surfaces of the regional components with a rubbing material to obtain planar extension units corresponding to each regional components, and cutting materials and labeling the cut plates with tags corresponding each regional components;
performing outward scaling based on the inclined surface, [symbol] -shaped convex surface or [symbol] shaped concave surface at the center of the main body portion according to shapes of other unit planes forming the main body portion, the connection portion and the side wall portion, obtaining sizes of the other unit planes by calculation or simulation, and cutting the material correspondingly;
when the inclined surface, the [symbol] -shaped convex surface or the [symbol] shaped concave surface is not disposed at the center of the main body portion, performing outward scaling based on the mold for the inclined surface, the [symbol] -shaped convex surface or the [symbol] shaped concave surface at the center of the main body portion according to predetermined shapes of the other unit planes forming the signboard, obtaining sizes of unit planes beyond the center of the main body portion by calculation or simulation, and cutting the material correspondingly; and obtaining a size of the unit plane at the center of the main body portion by the calculation or the simulation according to a height of the unit plane at the center of the main body portion of the signboard and a width thereof projected on the horizontal and then cutting the material correspondingly;
S3: obtaining sizes of other unit planes by the calculation according to the mold for the inclined surface, the [symbol] -shaped convex surface or the [symbol] shaped concave surface manufactured at the center of the main body portion when unit planes forming the signboard comprise a unit plane having at least two inclined surfaces, the [symbol] -shaped convex surfaces or the [symbol] shaped concave surfaces and there is the same inclined angle for the inclined surfaces and inclined surfaces forming the [symbol] -shaped convex surface or the [symbol] shaped concave surface; and
repeatedly performing the steps S1 and S2 sequentially based on different inclined angles of inclined surfaces or inclined surfaces forming the [symbol] -shaped convex surface or the [symbol] shaped concave surface when the unit planes forming the signboard comprise at least two inclined surfaces, the [symbol] -shaped convex surfaces or the [symbol] shaped concave surfaces and there are different inclined angles for the inclined surfaces or inclined surfaces forming the [symbol] -shaped convex surface or the [symbol] shaped concave surface; and
S4: integrating the plates cut in the step S2 according to the tags and the shapes of the unit planes based on the patterns of the signboard so as to form an overall identification shape of the three-dimensional signboard.

8. The method for manufacturing a three-dimensional signboard as claimed in claim 7, characterized in that, heights of an overall signboard and the unit planes forming the signboard and widths thereof projected on the horizontal are determined; when the unit planes forming the signboard comprises the horizontal surface, the vertical surface, the convex chambered surface or the concave chambered surface, sizes of the unit planes are obtained by the calculation comprising: calculating sizes of planar extension units of the unit planes according to the widths of the unit planes projected on the horizontal and the heights thereof; when the unit planes forming the signboard comprise the convex chambered surface or the concave chambered surface with the curved chambered surface, obtaining the sizes of the unit planes by the simulation comprising: printing patterns of a cross section of the signboard, simulating and copying with a soft rope or a sticker according to the patterns printed and calculating a size of the convex chambered surface or concave chambered surface.

9. The method for manufacturing a three-dimensional signboard as claimed claim 8, characterized in that, perforating hollowed surfaces of the main body portion, the connection portion and the side wall portion, wherein perforated regions in predetermined positions are located by the calculation or the simulation, and then the perforated regions located are perforated; the hollowed regions of the main body portion and the connection portion are set off by a non-opaque resin material, non-opaque organic glass sheet material or non-opaque adhesive material; and the main body portion, the connection portion and the side wall portion are manufactured from materials including metal, organic glass, Chevron board, glass fiber reinforced plastics, wood, polycarbonate or polyvinyl fluoride.

10. A method for manufacturing a three-dimensional signboard, characterized in that, at least one of a main body portion, a connection portion and a side wall portion of the signboard is formed by at least one unit plane, the unit plane comprising a horizontal surface, a vertical surface, a concave chambered surface, a convex chambered surface and a curved chambered surface; the method comprising:
determining heights of an overall signboard and the unit planes forming the signboard and widths thereof projected on the horizontal; when the unit planes forming the signboard comprise the horizontal surface, the vertical surface, the convex chambered surface or the concave chambered surface, sizes of the unit planes are obtained by the calculation comprising calculating sizes of planar extension units of the unit planes according to the widths of the unit planes projected on the horizontal and the heights thereof; and when the unit planes forming the signboard are the convex chambered surface or concave chambered surface and the surface of the convex chambered surface or concave chambered surface is a curved surface, sizes of the unit planes can be obtained by the simulation comprising printing patterns of a cross section of the signboard, simulating and copying by using a soft rope or a sticker according to the patterns printed, and calculating the size of the convex chambered surface or concave chambered surface; and
cutting materials according to the sizes of the unit planes forming the signboard, and integrating the cut material according to the patterns of the signboard so as to form an overall identification shape of the three-dimensional signboard.

11. The method for manufacturing a three-dimensional signboard as claimed in claim 10, characterized in that, perforating hollowed surfaces of the main body portion, the connection portion and the side wall portion, wherein perforated regions in predetermined positions are located by the calculation or the simulation, and then perforating the perforated regions located; the hollowed regions of the main body portion and the connection portion are set off by a non-opaque resin material, non-opaque organic glass sheet material or non-opaque adhesive material; and the main body portion, the connection portion and the side wall portion are manufactured from materials including metal, organic glass, Chevron board, glass fiber reinforced plastics, wood, polycarbonate or polyvinyl fluoride.
